(19) United States
(12) Patent Application Publication
(10) Pub. No.: US 2014/0169056 A1
(43) Pub. Date: Jun. 19, 2014

(54) CLEAN ENERGY GENERATING DEVICE

(71) Applicant: YI-YI CHEN, New TAIPEI City (TW)

(72) Inventor: YI-YI CHEN, New TAIPEI City (TW)

(21) Appl. No.: 14/105,202

(22) Filed: Dec. 13, 2013

(30) Foreign Application Priority Data
Dec. 14, 2012 (TW) 101224314

(51) Int. Cl. H02M 7/02

(52) U.S. Cl. CPC H02M 7/02
USPC 363/140

(57) ABSTRACT

The present invention is related to a clean energy generating device which includes coiled or spiral shaped conductors, for receiving electromagnetic wave and inducing electric current, and elements which can create magnetic fields passing through the coiled or spiral shaped conductors for rectifying alternating current (AC) and transforming random electron movement from heat into direct current (DC) at the same time. The direct current (DC) is usable by an electronic device to supply power. The length, number of circles and the radius of the circles of the coiled or spiral shaped conductors are not limited and can be adjusted for receiving and rectifying effect. Thus, this invention make effective use of electromagnetic radiation and heat in the air to produce electricity. Furthermore, it can be combined with a specially designed unit to produce hydrogen from water to achieve output of clean energy fuel and practical purposes.

### BACKGROUND OF THE DISCLOSURE

a) Field of the Disclosure

This invention relates to a clean energy generating device, and more particularly, to a clean energy generating device having a function of receiving and transforming electromagnetic wave and heat into direct current (DC). Furthermore, it can then be combined with a specially designed unit to produce hydrogen from water to achieve output of clean energy fuel and practical purposes. The present invention extends a previous invention by the same inventor using magnetic field and geometry shape for transforming alternating current (AC) and random electron movement due to heat into direct current (DC). With coiled or spiral shaped conductors, receiving and rectification can happen at the same time, continuously in one component. The length, number of circles and the radius of the circles of the coiled or spiral shaped conductors are not limited and can be adjusted for receiving and rectifying effect. (e.g. With 1000˜0.01 μm in radius, infrared radiation and heat can be converted to direct current (DC)).

b) Brief Description of the Related Art

Current electricity consumption is so enormous that various ways to generate electricity are devoted to be researched in various parties. For example, wind power or sea flow can be transformed into electric power.

Traditional sources of energy, for example, coal, oil, produce large amount of carbon dioxide and toxic causing greenhouse effect, acid rain hazardous to the Earth's environment. Using hydrogen as fuel does not produce carbon dioxide and using hydrogen fuel to power a car does not take a long time to recharge. Portable hydrogen power generation systems and fuel cells to store energy will help bring more well-being of human life.

### SUMMARY OF THE DISCLOSURE

In order to improve the above disadvantages, the inventors collected related information, had evaluation and consideration in many ways based on long experience in this field and straight did tests and modification, and finally an clean energy generating device having a function of collecting and transforming the energy of electromagnetic wave and heat into direct current (DC) and a device that can produce hydrogen from water can be developed.

In accordance with an objective of the present invention, the energy of electromagnetic wave and heat can be collected and used to supply power by a device which can receive electromagnetic wave and rectify electric current at the same time so as to transform the energy of electromagnetic wave and heat into a direct current (DC) receivable by an electronic device. Furthermore, it can be combined with specially designed units to turn water into hydrogen to achieve output of clean energy fuel and practical purposes.

In order to achieve the above objective, a main structure in accordance with the present invention includes multiple coiled or spiral shaped conductors and elements which can create magnetic field passing through the coiled or spiral shaped conductors. The coiled or spiral shaped conductors receive electromagnetic wave and transform the energy of electromagnetic wave and heat into electron movement. At the same time the loop or spiral shape and the magnetic field rectify the electron movement into direct current (DC). When the coiled or spiral shaped conductors receive electromagnetic wave and heat, moving electrons in a magnetic field are affected by a magnetic force such that electrons tend to move in one direction (e.g. clockwise) more easily than the other direction (e.g. counter-clockwise). Thereby, current rectification can be achieved and the electron movement from electromagnetic wave and heat can be transformed into the direct currents (DC). Furthermore, a specially designed unit connected with the coiled or spiral shape conductors and comprising highly selectively permeable proton exchange membrane and charged components, creating electric field; and components, creating magnetic field, wherein the electric field and magnetic field facilitate protons moving toward one side without reducing the charge and electric field can be used to produce hydrogen from water.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a structural block diagram in accordance with an embodiment of the present invention.

FIG. 2 is a schematic view of a electromagnetic wave receiver operating in accordance with an embodiment of the present invention.

FIG. 3 shows how current rectification can be achieved in accordance with an embodiment of the present invention because moving electrons in a magnetic field are affected by a magnetic force such that electrons tend to move in one direction (clockwise) more easily than the other direction (counter-clockwise).

FIG. 4 shows one shape of the conductor, the direction of the magnetic field and the rectified direction of electron movement in accordance with an embodiment of the present invention.

FIG. 5 shows another shape of the conductor and the rectified direction of electron movement with a magnetic field pointing perpendicularly into paper in accordance with an embodiment of the present invention.

FIG. 6 is a schematic view in accordance with a first embodiment of the present invention.

FIG. 7 is a schematic view in accordance with a second embodiment of the present invention.

FIG. 8 is a schematic view in accordance with a third embodiment of the present invention.

FIG. 9 is a schematic view in accordance with a fourth embodiment of the present invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

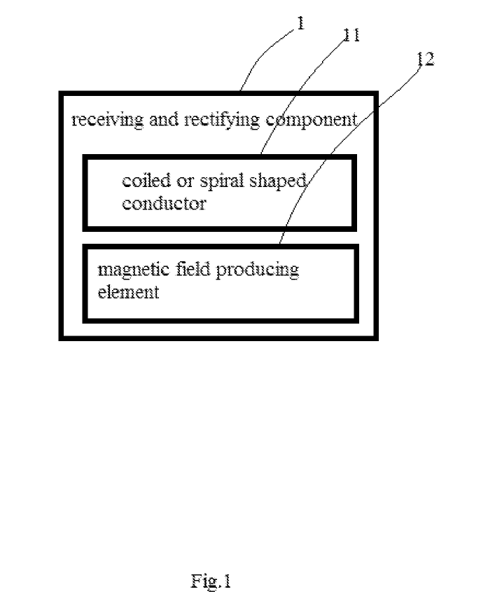

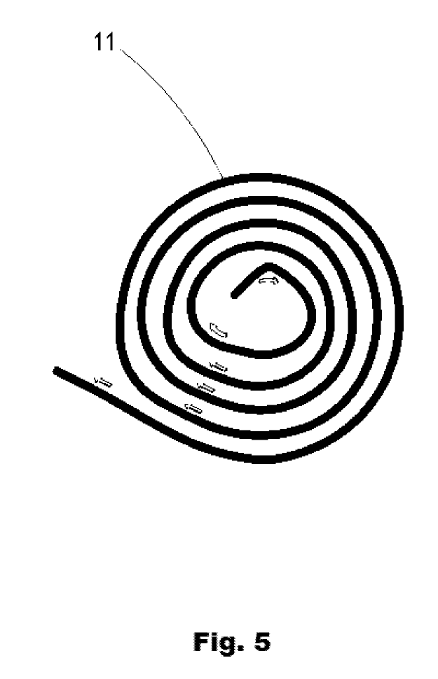

FIG. 1 is a structural block diagram in accordance with an embodiment of the present invention. Referring to FIG. 1, a main structure in accordance with the present invention includes at least a receiving and rectifying component 1 including at least a coiled or spiral shaped conductor 11, for receiving electromagnetic wave, and at least an element 12 which can create magnetic field passing through the coiled or spiral shaped conductor, wherein the coiled or spiral shaped conductors transform the electromagnetic wave energy into electric current and at the same time the magnetic field and the ring or spiral shape of the conductor rectify and transform the alternating current (AC) and random electron movement due to heat into direct current (DC). Besides, if nano-scale spiral shaped conductor as in FIG. 5 is chosen, using nanotechnologies, spiral shaped conductors can be formed on a silicon chip by a process comprising etching, and then arranged on the substrate by a process comprising pressing and printing. The size of the coiled or spiral shaped conductor is not limited and can be adjusted.

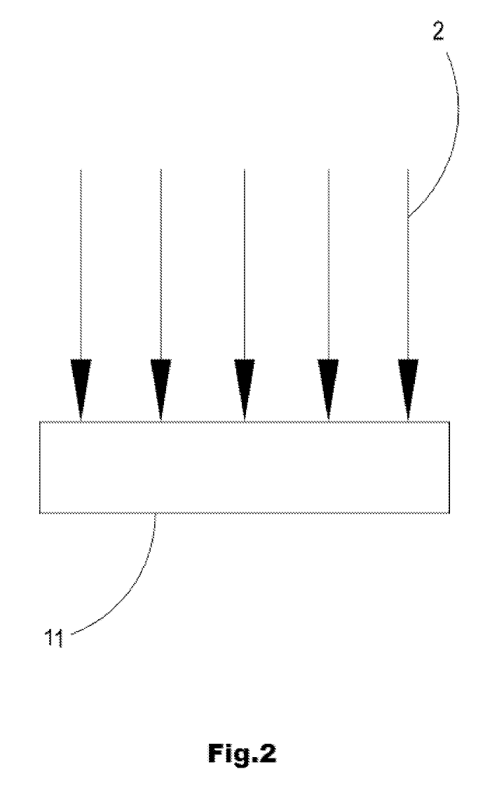

Using the above structure, the operation in accordance with the present invention is described as below. FIGS. 1-3 are a structural block diagram and schematic views of an electromagnetic wave receiver and how current rectification is achieved in accordance with an embodiment of the present invention. Referring to FIGS. 1-3, the coiled or spiral shaped conductor 11 receives electromagnetic wave 2 in the surrounding environment and electric current is induced. At the same time, the alternating current (AC) and random electron movement due to heat can be rectified by the magnetic field produced by element 12 and the shape of the conductor 11 and transformed into direct current (DC), described as below.

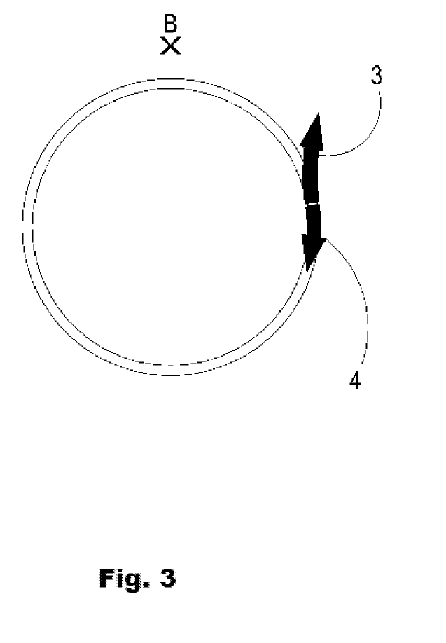

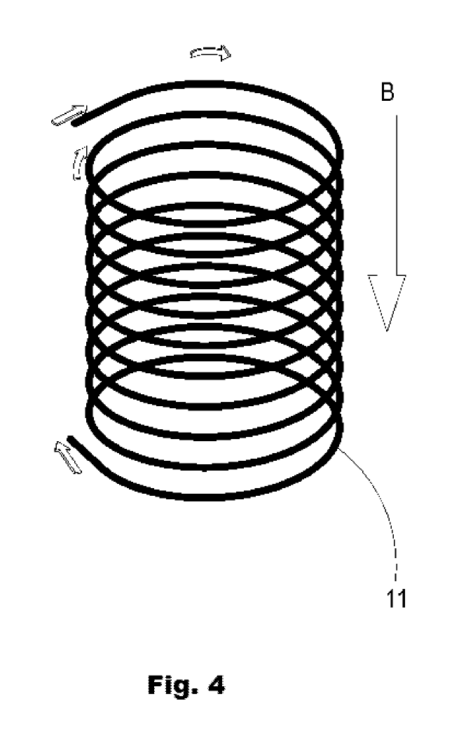

Referring to FIGS. 3, because the shape of conductor and moving electrons 3 and 4 in a magnetic field are affected by a magnetic force created by the magnetic field creating element 12 such that electrons tend to move in one direction 4 (clockwise) more easily than the other direction (counter-clockwise). According, FIG. 4 shows one shape of the conductor, the direction of the magnetic field and the rectified direction of electron movement in accordance with an embodiment of the present invention and FIG. 5 shows another shape of the conductor and the rectified direction of electron movement with a magnetic field pointing perpendicularly into paper in accordance with an embodiment of the present invention.

Thus, current rectification can be achieved and the alternating current (AC)) and random electron movement due to heat can be transformed into the direct current (DC).

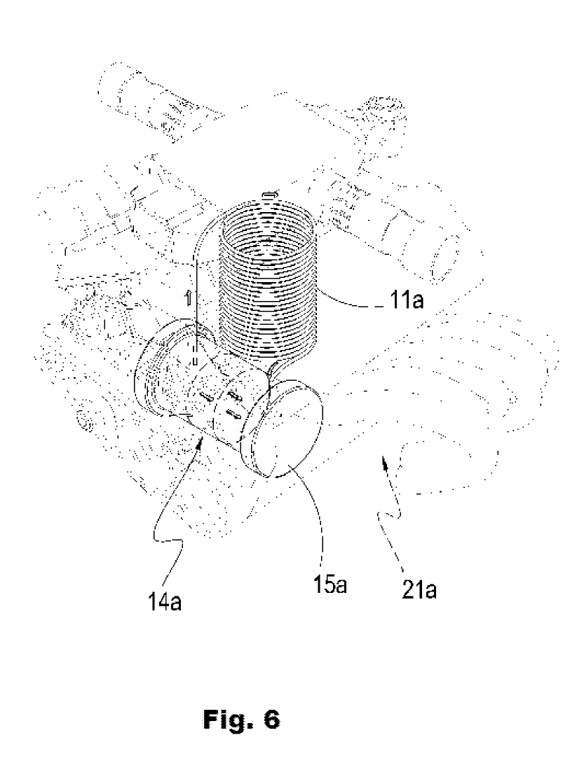

FIG. 6 is a schematic view in accordance with a first embodiment of the present invention. In this embodiment, hydrogen generator 14a can be set near a car engine 21a, the hydrogen generator 14a with a highly selectively permeable proton exchange membrane is connected with the coiled or spiral shaped conductor receiver 11a and the hydrogen generator 14a includes charged component 15a which can create electric field facilitating protons moving to one side without reducing the charge or the electric field and by adding water into the hydrogen generator 14a, hydrogen fuel can be produced to power car engine 21a.

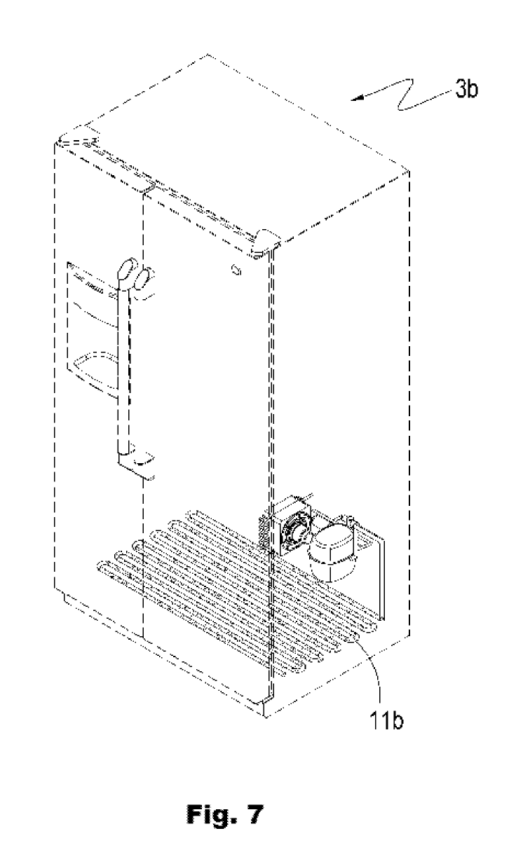

FIG. 7 is a schematic view in accordance with a second embodiment of the present invention. In this embodiment, the coiled or spiral shaped conductor receivers 11b can be set at a heat radiator of a refrigerator 3b. Thereby, the electromagnetic wave and heat created by the refrigerator 3b can be received and transformed into electric power.

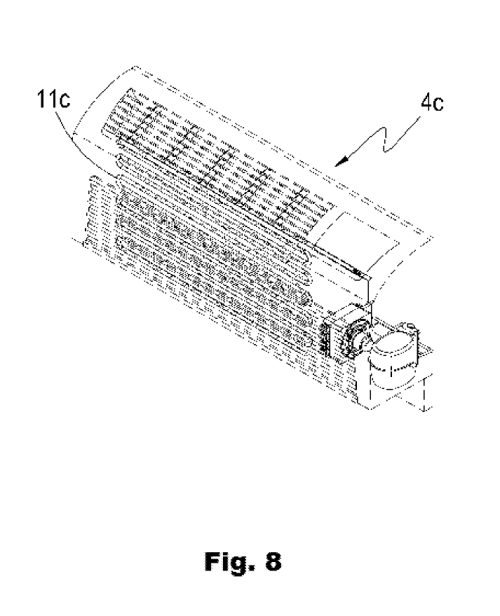

FIG. 8 is a schematic view in accordance with a third embodiment of the present invention. In this embodiment, the coiled or spiral shaped conductor receivers 11c can be set at a heat radiator of an air conditioner 4c. Thereby, the electromagnetic wave and heat created by the air conditioner 4c can be received and transformed into electric power.

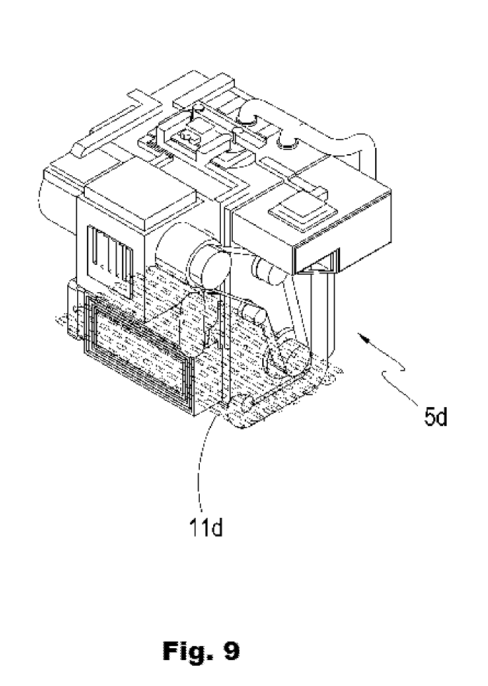

FIG. 9 is a schematic view in accordance with a fourth embodiment of the present invention. In this embodiment, the coiled or spiral shaped conductor receivers 11d can be set at an engine 5d of an electric car. Thereby, the electromagnetic wave and heat created by the engine 5d of the electric car can be received and transformed into electric power.

Accordingly, compared with the prior art, the present invention has the following advantages:

Electromagnetic wave 2 and heat in the surrounding environment can be can be well received and transformed into direct current (DC) usable by an electronic device and hydrogen can be produced from water to achieve output of clean energy fuel and practical purposes (e.g. powering car engines).

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A clean energy generating device comprising:
at least a receiving and rectifying component including:
at least a coiled or spiral shaped conductor, for receiving electromagnetic wave, wherein the coiled or spiral shaped conductor transform the electromagnetic wave energy into electric current ; and
at least an element which can create magnetic field passing through the coiled or spiral shaped conductor, wherein the magnetic field and the shape of the conductor rectify and transform the alternating current (AC) and random electron movement due to heat into direct currents (DC).

2. The clean energy generating device of claim 1, wherein if nano-scale spiral shaped conductor as in FIG. 5 is chosen, using nanotechnologies, spiral shape conductors can be formed on a silicon chip by a process comprising etching, and then arranged on the substrate by a process comprising pressing and printing.

3. The clean energy generating device of claim 1, wherein the length, number of circles and the radius of the circles of the coiled or spiral shaped conductors are not limited and can be adjusted for receiving and rectifying effect.

4. A clean energy generating device comprising:
at least a receiving and rectifying component including:
at least a coiled or spiral shaped conductor, for receiving electromagnetic wave, wherein the coiled or spiral shaped conductor transform the electromagnetic wave energy into electric current; and
at least an element which can create magnetic field passing through the coiled or spiral shaped conductor, wherein the magnetic field and the shape of the conductor rectify and transform the alternating current (AC) and random electron movement due to heat into direct currents (DC); and
at least a hydrogen generator, connected with the receiving and rectifying component, comprising
at least a highly selectively permeable proton exchange membrane; and
several charged components, creating electric field; and
several components, creating magnetic field, wherein the electric field and magnetic field facilitate protons moving to one side without reducing the charge and the electric field.

5. The clean energy generating device of claim 4, wherein if nano-scale spiral shaped conductor as in FIG. 5 is chosen, using nanotechnologies, spiral shaped conductors can be formed on a silicon chip by a process comprising etching, and then arranged on the substrate by a process comprising pressing and printing.

6. The clean energy generating device of claim 4, wherein the length, number of circles and the radius of the circles of the coiled or spiral shaped conductors are not limited and can be adjusted for receiving and rectifying effect.
